(19) United States
(12) Patent Application Publication
(10) Pub. No.: US 2021/0290028 A1
(43) Pub. Date: Sep. 23, 2021

(54) WALL CLEANING TOOL

(71) Applicant: MICRONOVA MANUFACTURING, INC., Torrance, CA (US)

(72) Inventors: Lorena Martinez, Downey, CA (US); Phillip LeCompte, Anaheim, CA (US)

(73) Assignee: MICRONOVA MANUFACTURING, INC., Torrance, CA (US)

(21) Appl. No.: 17/262,176

(22) PCT Filed: Jul. 26, 2019
(86) PCT No.: PCT/US19/43633

§ 371 Date: Jan. 21, 2021

Related U.S. Application Data
(60) Provisional application No. 62/703,864, filed on Jul. 26, 2018.

(51) Int. Cl. A47L 13/254; B29C 43/02; A47L 13/42; B29C 43/00

(52) U.S. Cl. CPC A47L 13/254; B29C 43/021; B29K 2027/18; B29C 43/003; A47L 13/42

(57) ABSTRACT

A cleaning tool includes a base wall and at least one curving wall extending away from the base wall and upward in a direction away from a surface to be cleaned.

### BACKGROUND

### Field

These inventions relate to wall cleaning tools, methods of manufacturing and using such tools, and including for example tools for cleaning flat wall and ceiling surfaces and their intersections and corners, and for example tools for cleaning walls and coving surfaces.

### SUMMARY

Cleaning tools, including mopping tools and wiping tools, for use on flat surfaces may be used for cleaning walls, ceilings and floors, and their intersections, for example covings at the vertical corners between adjacent walls, and at the horizontal corners between a wall and ceiling or floor. Covings at intersections of two walls and a ceiling or floor also require cleaning, and are often difficult to clean. Apparatus and methods are described for cleaning such surfaces.

In one example of a tool for cleaning flat surfaces and covings between them, the tool includes a tool element having a base wall for supporting a cleaning material such as a cleaning pad or cleaning fabric, and the base wall is configured to be supported by an adapter for a handle or other manipulating structure. In one example, the tool is formed from a resiliently flexible material, for example to allow forming the tool element to the desired shape, for example curvature. The tool element also includes at least one curving wall extending away from the base wall and outward from the base wall, for example curving upwardly and away from the work surface, namely the surface to be cleaned. In one example, the at least one curving wall maintains a substantially constant radius of curvature from the base wall to a free edge of the curving wall. In another example, the at least one curving wall follows a gradual curvature, wherein a radius of curvature of the curving wall may change from one location on the curving wall to another location on the curving wall while still providing a gradual curvature. For example, the gradual curvature can be defined by a changing radius of curvature where the changing radius of curvature from one area to another area on the curving wall in a direction away from the base wall changes by no more than one order of magnitude. In one example, the radius of curvature from one area to another area on the curving wall in a direction away from the base wall may change no more than 10%, and in another example no more than between 10% and 20%, and in a further example no more than between 5% and 10%.

In any of the foregoing examples of a tool, the tool can have a plurality of curving walls extending away from the base wall, for example in the same direction or in different directions. In one example, the tool can have at least a first and at least a second curving walls extending in opposite directions relative to each other away from the base wall and if desired, they may but need not have the same or substantially the same curvature. In one example, the first and second curving walls extend longitudinally of the tool and extend outwardly in directions opposite each other from the base wall. The shapes of each of the first and second curving walls as seen in transverse cross-section may be but need not be complementary, or mirror images of each other relative to a centerline extending longitudinally bisecting the first and second curving walls. The shapes of each of the first and second curving walls as seen in transverse cross-section may be constant over the entire longitudinal extent of the curving walls.

In the examples of the tool in the preceding paragraph having a plurality of curving walls, the first and second curving walls may extend longitudinally of the tool a greater distance than either of the curving walls extend away from a longitudinal centerline. Alternatively or additionally, one or more curving walls may extend transversely or approximately perpendicular to the longitudinal extent of the tool or of the longitudinal centerline. Such transverse or perpendicular curving walls may have the characteristics of any of the curving walls described herein. In one example, a tool such as one of those in the preceding paragraph may have first and second longitudinally extending curving walls each extending away from the base wall, and also first and second transversely extending curving walls also extending away from the base wall. The curvature of any one or more of the curving walls may have the characteristics of any of the curving walls described herein, and they may be identical to one or more of the characteristics of another of the curving walls.

In one example of a tool for cleaning flat surfaces and covings between them, the tool includes a base wall and first and second longitudinally extending walls curving outward from the base wall in opposite directions and away from a working surface of the base wall that would help to support a cleaning pad or cleaning fabric, and third and fourth walls curving outward from the base wall in opposite directions and transversely of the longitudinal extent of the tool. One or more of the first, second, third and fourth walls can have a curvature in the manner as described in any of the examples herein. In one example, each of the first, second, third and fourth walls has a substantially constant curvature from the base wall to a free end of the corresponding wall, and the curvatures of each of the first, second, third and fourth walls are but need not be substantially the same.

In any of the configurations of a cleaning tool described herein, adjacent curving walls are separated from each other by gaps or cutouts. For example, a gap or a cut out between adjacent curving walls occurs at respective corners, for example spaced apart from the longitudinal axis and from a transverse axis of the cleaning tool. A gap or cut out between adjacent curving walls is positioned for example at an end area of a longitudinally extending wall and at an adjacent end area of a transversely extending wall. A gap or cut out makes easier the formation of curving walls for the cleaning tool.

In any of the configurations of the cleaning tool described herein, the cleaning tool is formed in part from a sheet of Teflon or polytetrafluoroethylene (PTFE), and in one example virgin PTFE. The sheet may be monolithic. The sheet of PTFE is supported on a tool adapter, for example for a handle or other device for manipulating the tool by an adapter or other structure. The sheet of PTFE in one configuration has a substantially uniform thickness over the extent of the sheet, and in one example has a thickness of 0.0625 inch, and in another example can be thicker or thinner by up to between 10% and 20%. Additionally in one configuration, the sheet is 4.5″×14″ and cut to form as described herein. Other widths and lengths of the sheet can be selected according to the desired tool configuration.

These and other examples are set forth more fully below in conjunction with drawings, a brief description of which follows.

### BRIEF DESCRIPTION OF THE DRAWINGS

FIG. 1 is an upper isometric view of a cleaning tool assembly for cleaning walls, ceilings, floors and covings between them and other flat surfaces.

FIG. 2 is a front longitudinal section of the assembly of FIG. 1.

FIG. 3 is a transverse cross-section of the tool of FIG. 1.

FIG. 4 is an upper view of the tool of FIG. 1 and a cleaning pad or cleaning fabric for use there with.

FIG. 5 is an upper view of the tool of FIG. 1.

FIG. 6 is an upper and isometric view of the tool of FIG. 1.

FIG. 7 is a bottom plan view of the tool of FIG. 1.

FIG. 8 is a lower isometric view of a sheet blank that can be formed into a cleaning tool of the type illustrated in FIG. 1.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of tools and of methods of making and using the tools are described. Depending on what feature or features are incorporated in a given structure or a given method, benefits can be achieved in the structure or the method. For example, tools using gradually curving sidewalls extending from a base wall can be used for cleaning walls, ceilings, floors and other flat surfaces and covings between them. Such tools can be formed from thin sheets of PTFE, for example sheets of about 0.0625 inch, and a sheet may be monolithic or a one-piece sheet.

These and other benefits will become more apparent with consideration of the description of the examples herein. However, it should be understood that not all of the benefits or features discussed with respect to a particular example must be incorporated into a tool, component or method in order to achieve one or more benefits contemplated by these examples. Additionally, it should be understood that features of the examples can be incorporated into a tool, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

As used herein, “substantially” shall mean the designated parameter or configuration, plus or minus 10%. However, it should be understood that terminology used for orientation or relative position, such as front, rear, side, left and right, upper and lower, and the like, may be used in the Detailed Description for ease of understanding and reference, and may not be used as exclusive terms for the structures being described and illustrated.

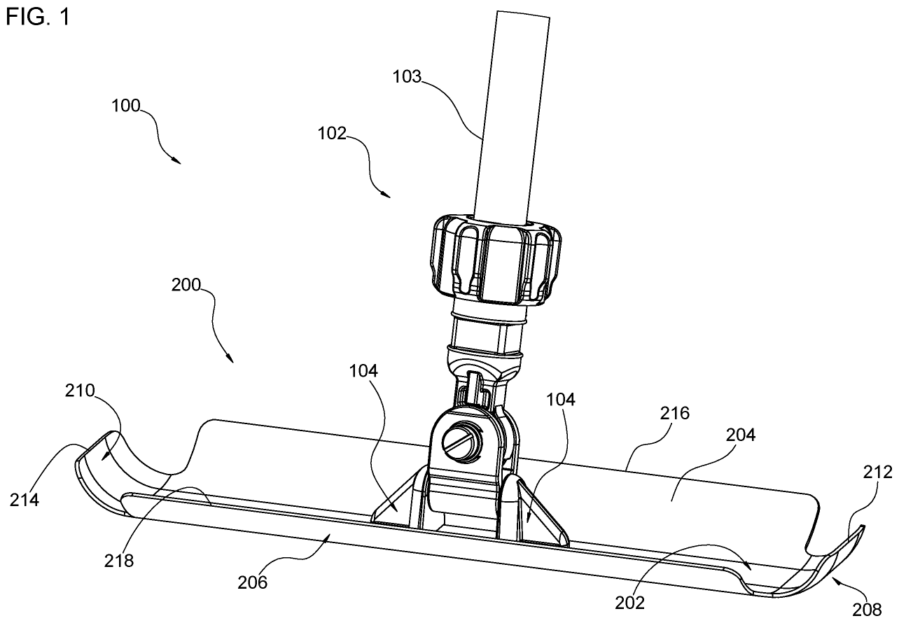

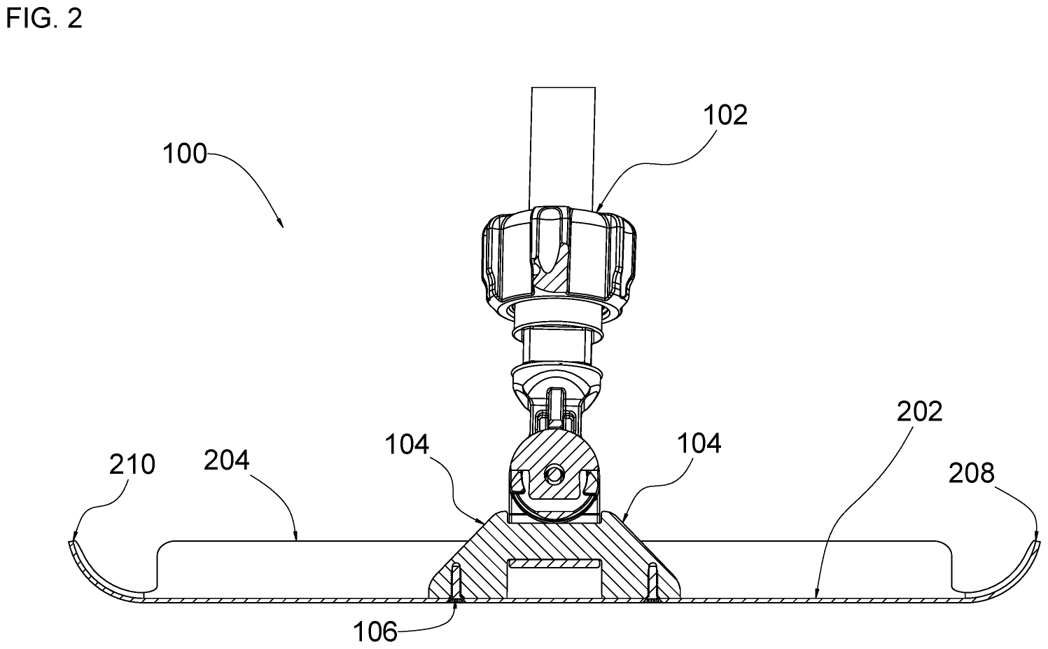

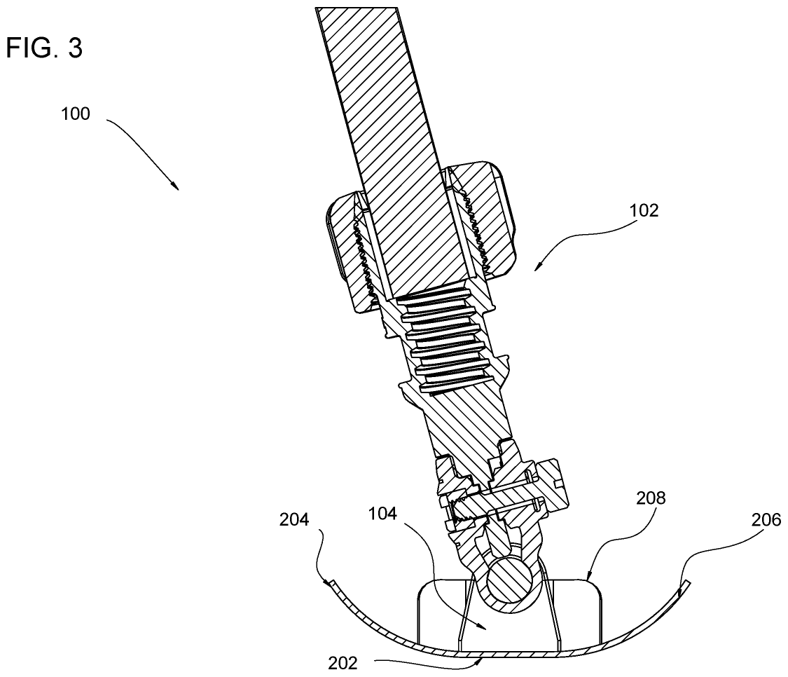

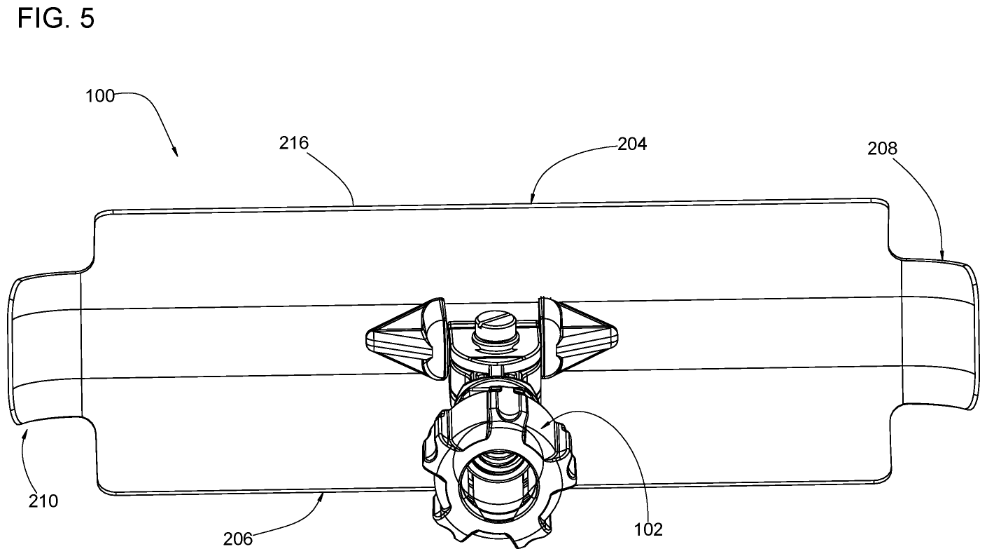

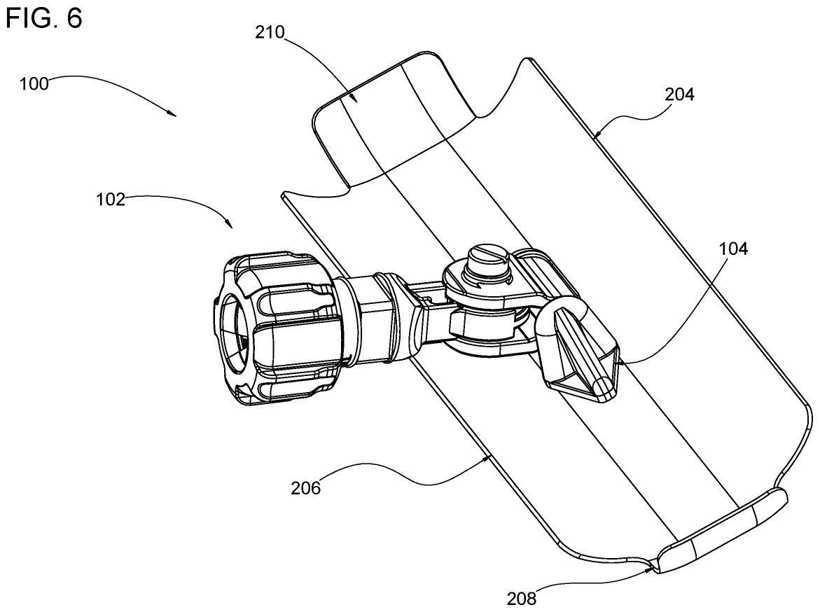

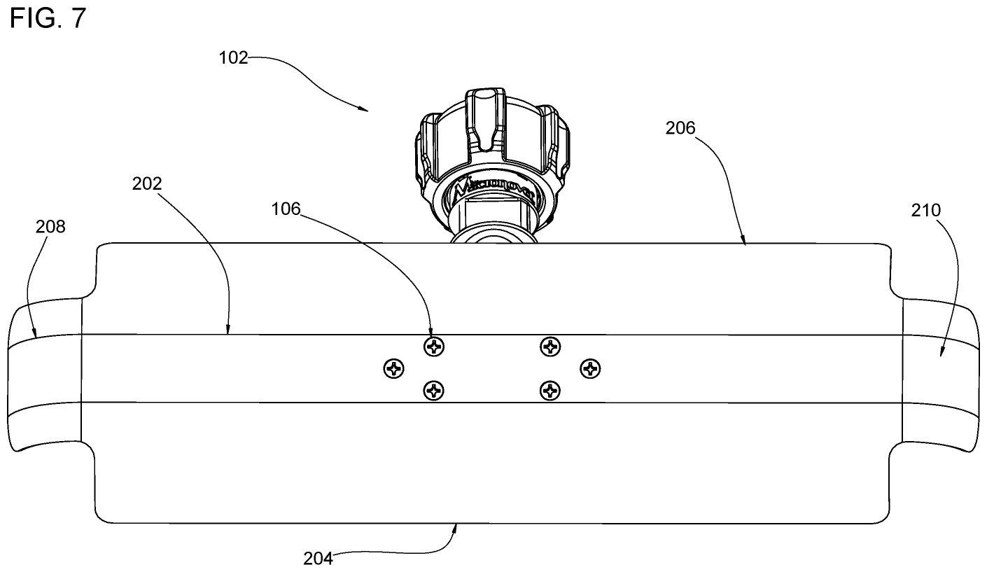

In one example of a cleaning tool (FIGS. 1-8), a cleaning tool assembly 100 includes a handle assembly 102 with a handle 103 and a cleaning tool element 200 controlled through the handle assembly, for example for cleaning walls, ceilings, floors and covings between them. The handle assembly 102 may be a conventional handle assembly, and may be one such as that described in WO2014151882, incorporated herein by reference. The handle assembly may be mounted or attached to the cleaning tool 200 through means for attaching the handle or movably supporting the tool element on a handle or other element for manipulating the cleaning tool. The means for attaching the handle may include any number of elements, including but not limited to mounting or support brackets 104, which may be secured for example by appropriate fasteners such as screws 106 (FIG. 7), mop handle adapters, threaded connections, pivot joints, U-joints, acme fasteners or other mounting, securing or fastening means. The mounting means and the cleaning tool 200 may be secured together with fasteners, bonding, welding, adhesive, or other means for securing two parts together.

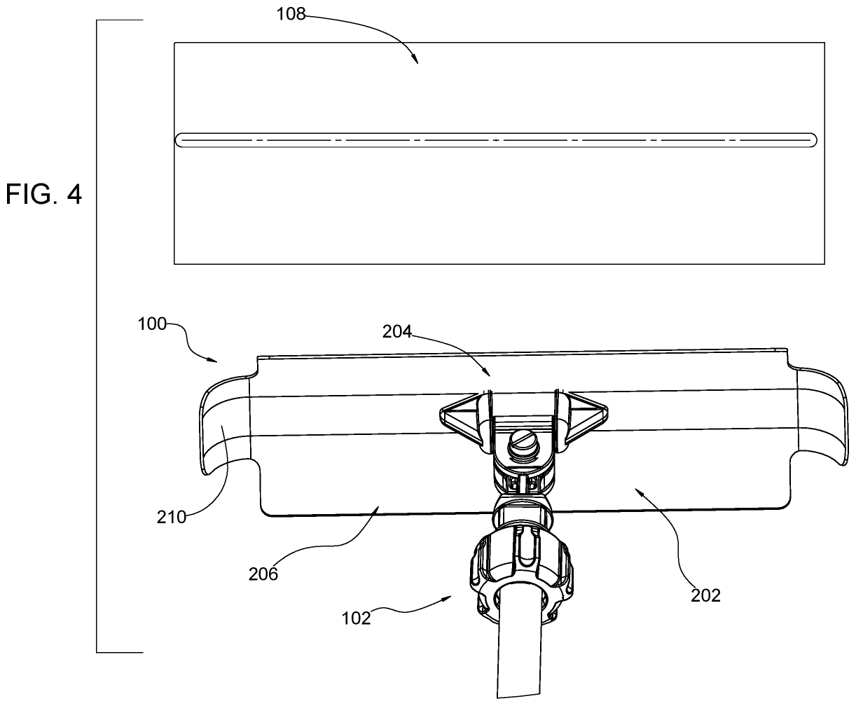

The cleaning tool 200 supports a cleaning fabric or cleaning pad 108, for example as shown in FIG. 4. The cleaning pad may be a conventional slip-on cleaning pad.

The tool 200 includes a base wall 202 extending longitudinally or lengthwise from a central area where the support brackets 104 are mounted, and also widthwise. The base wall may be substantially planar, as represented in the Figures, may be convex as would be viewed from the side facing the surface to be cleaned, or may be a complex curve of straight and curved portions.

The tool element 200 includes at least one curving wall, and in the examples illustrated, a plurality of curving walls, such as first, second, third and fourth curving walls 204, 206, 208 and 210, respectively. In one example, each of the curving walls can have a curvature identical to each of the other curving walls, or pairs of walls can have a curvature identical to each other, or each wall can have a curvature different from each of the other walls.

In the illustrated example, each curving wall extends upwardly and away from the work surface and away from the base wall, forming for example a convex surface as viewed from the work surface. In the configuration illustrated in the drawings, the longitudinally extending curving walls 204 and 206 have a constant radius of curvature at a given longitudinal position along the tool. Alternatively, a given curving wall can have a gradually changing radius of curvature as the wall progresses outward from the base wall 202. In the illustrated examples, the first and second curving walls 204 and 206 are substantial mirror images of each other about a longitudinal plane bisecting the tool. Additionally, the first and second curving walls 204 and 206 each have the same radius of curvature at different longitudinal positions along the tool.

In one example, the tool element 200 also includes at least one and in the present example two transversely extending curving walls 208 and 210. In one example, the curving walls 208 and 210 have a substantially constant radius of curvature at any given area widthwise, and the radius of curvature is the same at different widthwise positions. The third and fourth curving walls 208 and 210 are smaller in surface area than the first and second curving walls 204 and 206, but may extend away from the base wall to an end surface approximately the same amount as the spacing of the first and second curving walls.

In the example illustrated, the third and fourth curving walls 208 and 210 include a slight cupping or curvature in the widthwise direction, and therefore have a curvature in a plane parallel to the respective free ends 212 and 214 of the third and fourth curving walls. The free ends 212 and 214 are shorter than the free ends 216 and 218 of the longitudinally extending curving walls 204 and 206, respectively.

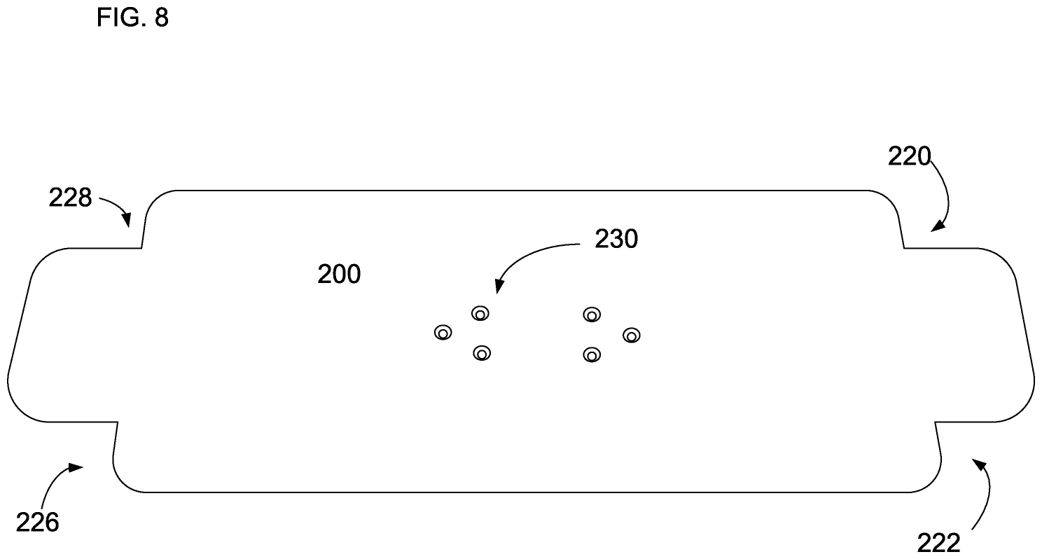

Adjacent ones of the curving walls, for example 204 and 208, 204 and 210, 208 and 206, and 206 and 210 are separated from each other by respective cutouts, for example cutouts 220, 222, 226, and 228 (FIG. 8). The cutouts are substantially rectangular and may be cut from a substantially rectangular sheet of material to form the flat blank illustrated in FIG. 8. The cut flat blank can then be mounted to an adapter or other means for attaching a tool handle and shipped flat, having the configuration shown in FIG. 8. The end user than shapes the tool element 200 so that the first, second, third and fourth walls curve as desired.

The sheet may be formed from a variety of materials, and in the present example formed from a sheet of polytetrafluoroethylene, and in one example Virgin PTFE. The sheet of PTFE has a substantially uniform thickness over the extent of the sheet, and in one example has a thickness of approximately 0.0625 inch.

The tool may be formed from a 4.5″×14″ rectangular sheet and cut to the form illustrated in FIG. 8. The corners 220, 222, 226 and 228 are cut from the sheet, and countersink openings 230 are formed for receiving the fasteners 106 to mount the tool on the brackets.

The tool is formed by pressing or otherwise forming the curving walls to the desired curvature. For example, the tool can be pressed into a form with the desired curvature, and possibly taking into account natural resiliency in the material so that the desired final curvature is achieved. This can be done at the time the components are assembled, or by the end user.

A cleaning pad or cleaning material is placed on the tool 200 and secured as desired. With or without a cleaning solution or compound, the tool is moved along a surface, such as a wall, ceiling or floor, for example vertically up and down with the longitudinal portion of the tool extending horizontally. As the tool approaches a junction with the ceiling for example, the tool fits into coving formed in the junction between the wall and the ceiling. The tool can be moved laterally along the coving and/or along one or more of the adjacent surfaces. As the tool approaches an adjacent vertical wall, the widthwise curving wall 208 or 210 extends into the coving between adjacent vertical walls. The tool can be moved so that the longitudinal portion of the tool extends vertically in the coving, and the coving and/or adjacent surfaces cleaned as desired. Other orientations and directions of motion may also be used for the tool.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

1. A tool element for supporting a cleaning element for cleaning an intersection between a wall and another surface, the tool element comprising a base wall for supporting a cleaning element on a working side of the base wall, the base wall including means for attaching a tool handle, the base wall extending in a longitudinal direction, and a resiliently flexible curved wall portion coupled to the base wall along a longitudinal side of the base wall where the curved wall portion curves outwardly from the base wall and toward a side of the base wall opposite the working side of the base wall.

2. The tool element of claim 1 wherein the curved wall portion is a first curved wall portion and further including a second curved wall portion coupled to the base wall along a longitudinal side of the base wall opposite the first curved wall portion, and further including third and fourth curved wall portions coupled to the base and extending transversely of the longitudinal direction at respective end portions of the base wall.

3. The tool element of claim 1 wherein the first, second, third and fourth curved wall portions are each curved away from the base wall and in a direction of the side of the base wall opposite the working side of the base wall.

4. The tool element of claim 1 wherein a curved wall portion has a substantially constant radius of curvature from the base wall to a free edge of the curved wall portion.

5. The tool element of claim 1 wherein a portion of the base wall is curved in a direction of the side of the base wall opposite the working side of the base wall.

6. The tool element of claim 1 wherein the base wall extends longitudinally a distance greater than a longitudinal extent of the curved wall portion.

7. The tool element of claim 1 wherein the base wall and the curved wall portion are monolithic.

8. The tool element of claim 1 wherein the base wall and the curved wall portion are formed from a resiliently flexible material.

9. The tool element of claim 1 wherein the base wall and the curved wall portion are formed from polytetrafluoroethylene.

10. The tool element of claim 1 wherein the base wall and the curved wall portion has a substantially uniform thickness of approximately 0.0625 inch.

11. A mop element formed from the tool element of claim 1.

12. A method of forming a tool element for use in supporting a cleaning element for cleaning and intersection between a wall and another surface, the method comprising forming from a sheet of resiliently flexible material a base wall having a working side and a support side so that the base wall extends in a longitudinal direction, and forming from the sheet of material a further wall portion extending from a side of the base wall; configuring the base wall to accept means for attaching a tool handle; and forming the further wall portion to extend upward in a direction away from the working side of the base wall.

13. The method of claim 12 further including forming the base wall and the further wall portion from a sheet having a uniform thickness.

14. The method of claim 12 further including forming the base wall and the further wall portion from a sheet of polytetrafluoroethylene.

15. The method of claim 12 wherein forming the further wall portion comprises forming a first wall portion extending from a side of the base wall, and further including forming second, third and fourth wall portions extending from respective sides of the base wall, and forming the second, third and fourth wall portions to curve upwardly in a direction away from the working side of the base wall.

16. The method of claim 12 wherein forming the base wall and the further wall portion from a sheet having a uniform thickness includes forming from a sheet having a thickness of approximately 0.062 inch.

17. A mop element for supporting a cleaning element for cleaning and intersection between a wall and another surface, the mop element comprising a base wall extending longitudinally for supporting a cleaning element on a working side of the base wall, a mop adapter secured to the base wall on a side of the base wall opposite the working side and configured to receive a handle for controlling the mop element, first, second, third, and fourth wall portions extending in respective directions from the base wall outwardly and upwardly in a direction away from the working side of the base wall, and wherein the first and second wall portions extend from opposite sides of the base wall, and the third and fourth wall portions extend from opposite sides of the base wall.

18. The mop element of claim 17 wherein the first and second wall portions extend longitudinally of the base wall, and the third and fourth wall portions extend transversely, and wherein the first, second, third, and fourth wall portions curve upwardly each with substantially a same radius of curvature.

19. The mop element of claim 17 wherein the base wall includes a portion that is curved.

20. The mop element of claim 17 wherein the base wall, first, second, third and fourth wall portions are formed monolithic.

21. The mop element of claim 17 wherein the base wall, first, second, third and fourth wall portions are formed from a single sheet of polytetrafluoroethylene.

22. The mop element of claim 17 wherein the base wall, first, second, third and fourth wall portions have a substantially uniform thickness of approximately 0.0625 inch.

23. The mop element of claim 17 wherein the first and second wall portions extend longitudinally of the base wall, and the third and fourth wall portions extend transversely of the base wall, and wherein at least one of the first, second, third, and fourth wall portions is curved with a radius of curvature that is not constant.

24. The mop element claim 17 further including a cleaning material supported by the base wall and the first, second, third and fourth wall portions.
